(19) United States
(12) Patent Application Publication
(10) Pub. No.: US 2006/0178913 A1
(43) Pub. Date: Aug. 10, 2006

(54) Medical and other consent information management system

(76) Inventors: Anne Lara, Wilmington, DE (US); Rajiv Prasad, Bryn Mawr, PA (US)

Correspondence Address: Siemens Corporation;Intellectual Property Department, 170 Wood Avenue South, Iselin, NJ, 08830, US

(21) Appl. No.: 11/324,421

(22) Filed: Jan. 3, 2006

Related U.S. Application Data
(60) Provisional application No. 60/651,453, filed on Feb. 9, 2005.

(51) Int. Cl. G06F 19/00; G06F 7/00

(52) U.S. Cl. 705/3; 707/102

(57) ABSTRACT

A system allows healthcare personnel to automatically associate patient related activities to an appropriate consent form and track the status of consent forms electronically. A consent information management system suitable for healthcare use, comprises at least one repository associating consent information of a particular patient with data identifying, a corresponding particular treatment provided to the particular patient and signatures validating consent obtained from the particular patient and other persons. A consent data processor uses the at least one repository and determines signatures required for a particular consent for providing a particular treatment to a particular patient are obtained.

This is a non-provisional application of provisional application Ser. No. 60/651,453 by A. Lara et al. filed Feb. 9, 2005.

### FIELD OF THE INVENTION

This invention concerns a consent information management system suitable for healthcare and other use involving tracking patient consent to receive a medical treatment, for example.

### BACKGROUND OF THE INVENTION

Many patient related activities occurring during treatment by a healthcare provider require a patient to sign a consent form. An individual consent form is valid for a specified period of time that may be variable dependent upon a policy of an individual hospital. Healthcare personnel are required to obtain and maintain valid consent forms for the performance of patient treatment activities. This task is typically manual and often a labor intensive one necessitating that Healthcare personnel know which activities require a consent form, recognize how long a particular consent form for a particular treatment is valid and review multiple copies of paper consent forms to acquire information. Managing consent information for a healthcare provider organization is often labor intensive, subject to human error and is burdensome. A system according to invention principles addresses these problems and associated problems.

### SUMMARY OF THE INVENTION

A system assists a user to identify which treatment procedures require a patient consent and who needs to sign a consent form and supports creation and viewing of an electronic consent form in a clinical information system as well as identification of status of a consent form as being complete and as either approaching expiration or being expired, based upon its validity duration. A consent information management system suitable for healthcare use, comprises at least one repository associating consent information of a particular patient with data identifying, a corresponding particular treatment provided to the particular patient and signatures validating consent obtained from the particular patient and other persons. A consent data processor uses the at least one repository and determines signatures required for a particular consent for providing a particular treatment to a particular patient are obtained.

### BRIEF DESCRIPTION OF THE DRAWING

FIG. 1 shows a networked hospital information system including a consent management system, according to invention principles.

FIG. 2 shows a flowchart of a consent management process, according to invention principles.

FIG. 3 shows a diagram of operations of a consent management system, according to invention principles.

FIG. 4 shows a flowchart of a consent management process sequence, according to invention principles.

FIG. 5 shows a consent management status tracking system, according to invention principles.

FIGS. 6 and 7 indicate consent management states used in a consent status tracking system, according to invention principles.

FIG. 8 shows a flowchart of a process employed by a consent management system, according to invention principles.

### DETAILED DESCRIPTION OF THE INVENTION

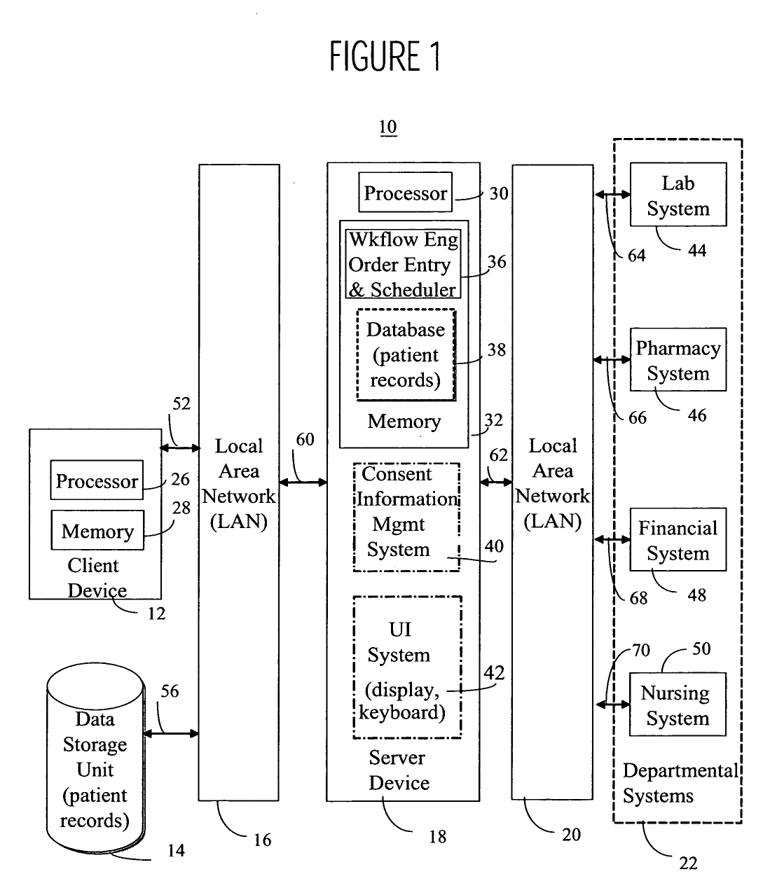

FIG. 1 shows a networked hospital information system including a consent information management system. The system allows healthcare personnel to automatically associate patient related activities to an appropriate consent form and track the status of consent forms electronically. A workflow employed by the consent information management system allows treatment activities and procedures requiring consents to be automatically identified and consent forms to be available to healthcare personnel. The system enables healthcare personnel to file and identify status of a consent form as signed and based upon the date of the signature, the system calculates the validity period of the consent form. A signed consent form is stored electronically and consent form information is immediately available to different healthcare personnel.

Many healthcare patient treatment activities and procedures require a client or patient to read and sign a consent form. In existing systems, the management of consent forms is typically a manual one, in which healthcare workers are responsible for, identifying when a consent is required, obtaining appropriate signatures on a consent form, filing a consent form, reviewing a consent form before a procedure is initiated and remembering how long a consent form is valid before another one needs to be signed. In contrast, consent management system 40 is employed by a clinical information system to assist a user to, identify which procedures require consents and who needs to sign the consent form. System 40 also supports a user in, storing the consent form electronically by either scanning a paper copy or creating an electronic form in the clinical information system, viewing a consent form within the clinical information system, identifying status of a consent form as complete and identifying when a consent form is either approaching expiration or is expired based upon its validity period. The system reduces administrative time and reduces the likelihood that procedures are initiated without signed consents and thereby improves workflow efficiency and patient safety.

Consent management system 40 manages patient consent workflow by identifying patient activities requiring consent and minimizing a need for patients to redundantly sign consent forms if a previously signed form cannot be located. This reduces healthcare personnel wasted time and potentially reduces hospital and physician liability through obtaining and maintaining required, valid consent forms for designated procedures and activities.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

FIG. 1 shows a hospital information system (HIS) 10 including consent management system 40 operating in conjunction with user interface system 42. User interface system 42 provides one or more display images presenting consent forms and consent form tracking and status information. HIS 10 includes a client device 12, a data storage unit 14, a first local area network (LAN) 16, a server device 18, a second local area network (LAN) 20 and departmental systems 22. Departmental systems 22 are systems that need access to information including consent form tracking and status information or provide information related to the health and/or welfare of patients in the care of the healthcare provider. Examples of the departmental systems 22 include, without limitation, a laboratory system 44, a pharmacy system 46, a financial system 48 and a nursing system 50, as shown in FIG. 1, but may also include a records system, a modality (e.g., radiology) system, an accounting system, a billing system, and any other system required or desired in a healthcare information system.

The hospital information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client. The client device 12, e.g., a workstation, includes processor 26 and memory unit 28 and may comprise a personal computer, for example. HIS 10 is used by a healthcare provider that is responsible for providing healthcare services within a hospital or as a separate facility.

Server device 18 includes consent management system 40, user interface 42, processor 30, a memory unit 32 including workflow engine, physician order entry and scheduling system 36 and a repository (database) 38 containing patient records. The user interface system 42 input device is a keyboard and mouse, but also may be a touch screen or a microphone with a voice recognition program, or a telephone voice response system for example. The output device, as an alternative (or in addition to) a display, may be a speaker, for example. The output device provides information to the user responsive to the input device receiving information from the user or responsive to other activity by client device 12. For example, a display presents information responsive to the user entering information via a keyboard. User interface system 42 (which may also reside in client device 12) includes an input device that permits a user to perform data and command entry and input information and an output device that provides a user display images showing consent forms and consent form tracking and status information.

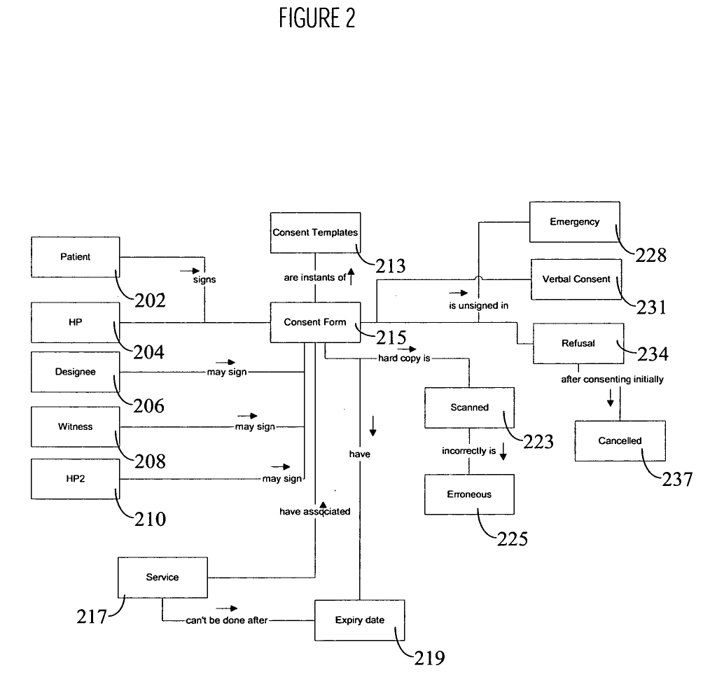

FIG. 2 shows a flowchart of a consent management process monitored and enabled by consent management system 40 operating in conjunction with user interface system 42. A patient 202, under supervision of a healthcare worker 204 using system 40, signs a consent form 215 comprising an instance (copy) of a template form 213 for a particular treatment procedure derived from repository 38 (FIG. 1). In the event patient 202 is incapable of giving a knowing, voluntary consent, a designee 206 (e.g., a previously designated relative, friend or other person) of patient 202 signs the consent form 215. System 40 indicates via one or more display images provided by user interface 42 who needs to sign consent form 215. For example, depending on hospital policy, and type of treatment procedure involved (and possibly regulatory requirements) witness 208 or healthcare worker 210 (e.g., a specialist or a personal physician of patient 202) may need to sign consent form 215. In the event of an emergency 228, system 40 indicates consent steps that are necessary to be performed by a healthcare worker or whether consent is unnecessary and indicates consent steps to be taken by a worker in the event a verbal consent 231 is obtained (e.g., when patient 202 is unable to sign). System 40 also indicates steps to be taken by a worker in the event that patient 202 refuses 234 to sign a consent or after initially giving consent cancels 237 a consent.

In response to manual or automatic command, system 40 scans 223 signed consent form 215 and also determines if form 215 has been incorrectly scanned or contains errors 225. System 40 initiates generation of an alert message to a user upon detection of a scanned consent form error. In addition, system 40 continuously monitors validity periods of signed consent forms through determining expiration dates 219 of signed consent forms by comparing execution dates of signed forms with predetermined validity periods for consent forms for particular procedures. System 40 alerts healthcare workers of expiration dates of consent forms for particular patients and that treatment services 217 covered by the corresponding consent may not be performed after the expiration date.

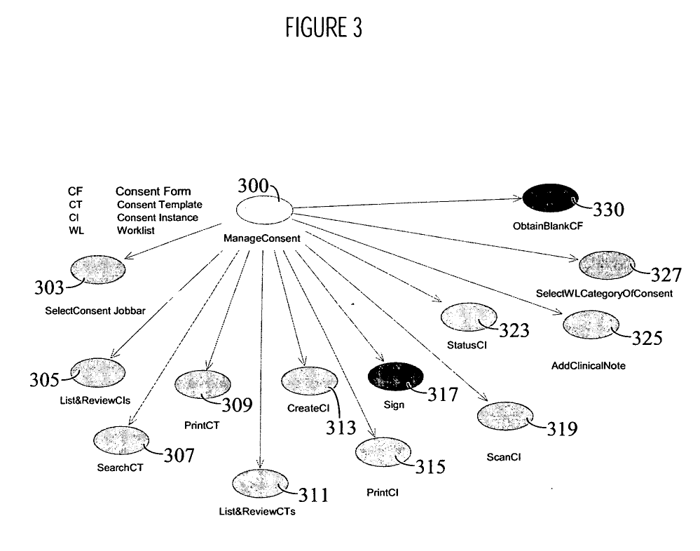

FIG. 3 shows a diagram of operations of consent management system 40 working together with user interface system 42. System 40 provides a central consent management function 300 that supports functions 303-330. Specifically, function 300 enables user selection of a consent form management function via a consent function selection task bar item 303 presented in a display image. System 42 and function 300 present display images providing a reviewable list 305 of consent forms (instances of consent template forms). The display images also enable a user to search a repository of template consent forms 307 to locate a desired template consent form in a reviewable list of template forms 311 and to print 309 a desired template consent form. Function 300 and display images provided by system 42 support user creation of a consent form instance 313 from a selected template consent form and print the form 315 for signing by a patient and others if indicated by system 40. A signed form 317 is scanned 319 into electronic form and stored in repository 38 (FIG. 1).

Function 300 and display images provided by system 42 support user access and display of the status 323 (e.g. determining expiration date and validity) of a particular signed consent form or multiple consent forms (e.g., of patients in a hospital department, wing or in a nursing unit, for example). A healthcare worker is able to add a clinical note 325 in management system 40 associated with a particular patient signed (or unsigned) consent form for storage in a patient consent form associated record. The display images provided by system 42 and function 300 also enable a user to select and review a worklist 327 of tasks to be performed by one or more healthcare workers in obtaining and maintaining a category of consent forms such as for patients of a particular nursing unit, or for scheduled surgery, for example. Function 300 also enables a user to access a blank consent form 330.

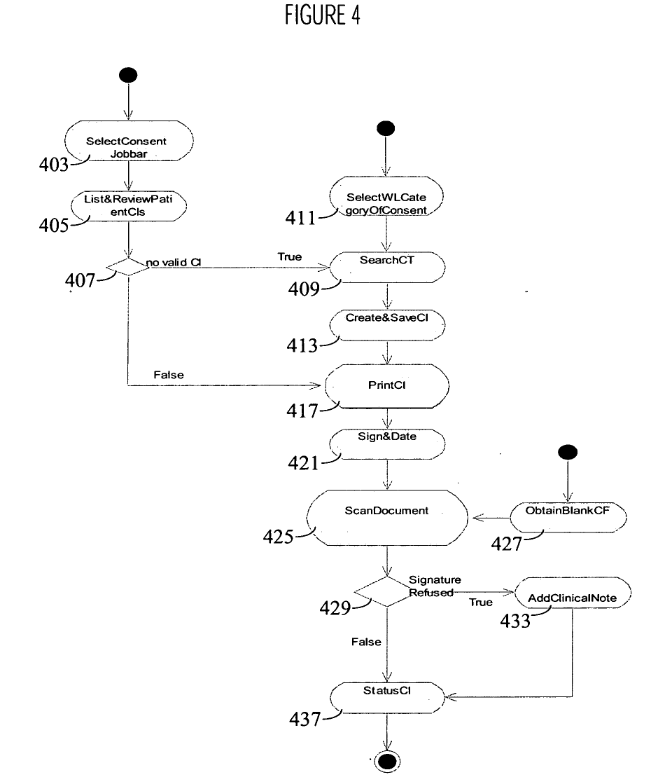

FIG. 4 shows a flowchart of a consent management process for obtaining and monitoring patient consent and associated signed forms performed by a user employing system 40 operating in conjunction with user interface system 42. Consent management system 40 and system 42 initiate generation of a display image including a consent function selection task bar in step 403 in response to user command. In step 405 in response to user command, system 40 operating with system 42 presents display images including a reviewable list 305 of consent forms (instances of consent template forms). If a user determines in step 407 that there is no currently valid instance of a consent form in the list for a particular patient treatment, or a task on a user worklist indicates a consent form is to be obtained for a particular patient treatment in step 411, a user initiates a search of available template consent forms in repository 38 in step 409. A user in step 413 employs a template consent form identified in step 409 to create and store an instance of the template consent form. A valid instance of a consent form for a particular patient treatment, following steps 407 and 413, is printed in step 417 and is signed and dated by a patient in step 421. The signed consent form is scanned into electronic form in step 425. A blank consent form may also be acquired in step 427 for scanning in to electronic form in step 425. If a patient refuses to sign a consent form in step 429, a healthcare worker adds a clinical note e.g., to a blank consent form or into an electronic patient record in step 433. In step 437 consent management system 40 and system 42 initiate generation of a display image showing status of signed consent forms, such as whether they are currently valid, their expiration dates and if current patient treatments are being provided that are covered by the consent form.

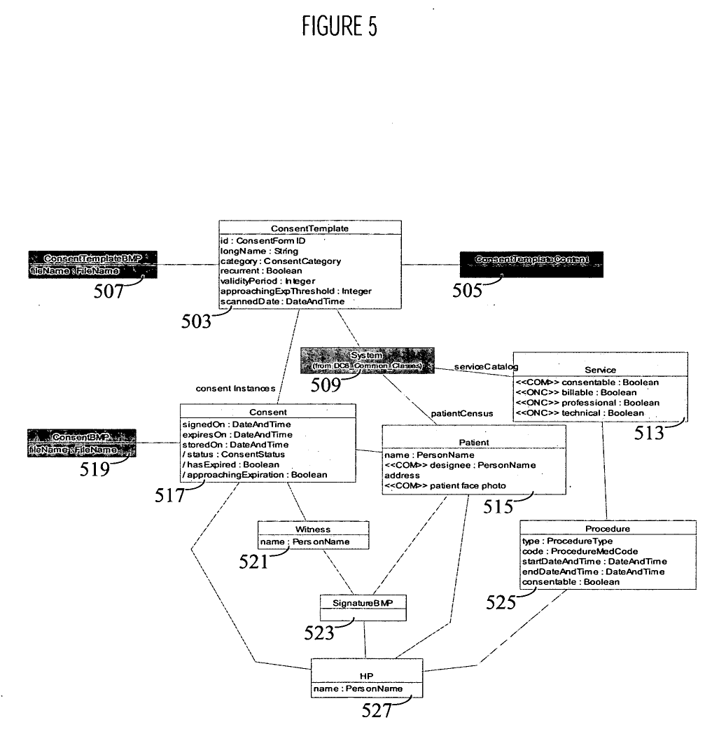

FIG. 5 shows a consent management status tracking system, showing consent management system XML (Extensible Markup Language) compatible record objects, for example and record associations used by consent management system 40 in the processes of FIGS. 2, 4 and 8. Consent template record object 503, associated with a consent form template bitmap file 507 and content data 505, conveys ancillary data including a consent form identifier, a name, a form category identifier, a Boolean expression (e.g., for use in determining a validity expiration date), a validity period, an approaching expiration indicator and a date and time of scanning. System 40 creates a consent form instance object 517 from consent template form and object 503. Consent form instance object 517, associated with a consent form template bitmap file 519, conveys ancillary data including a date and time of patient signature, a date and time of expiration, a date and time of storage, a status indicator, a Boolean expression (e.g., for use in determining a signed consent form has expired) and an approaching expiration indicator.

Consent form instance object 517 is associated with, witness object 521 conveying a witness name, signature bitmap object 523 for use in acquiring a witness name and signature and Healthcare Worker object 527 for conveying a healthcare worker name. Consent template record object 503 employs system 40 object oriented Classes 509 and associated objects including, a service catalog object 513, a patient object 515 and a procedure object 525. As known in the art, object-oriented programming language Class is used to define properties of an object and associated methods (procedures). A Class typically defines its own unique properties in addition to inheriting some properties. Service catalog object 513 conveys ancillary data including Boolean expressions for use in determining, who needs to sign a consent form for a particular patient treatment, billing requirements of a particular patient treatment, a particular medical professional that needs to obtain a signed consent form and technical requirements for execution of a consent form such as when it is to be signed etc. Patient object 515 conveys ancillary data including a patient name, a name and address of a designee to sign a consent form when a patient is unable to sign and a patient facial photograph, for example. Procedure object 525 conveys ancillary data including a procedure type identifier, a procedure or medication code, a time and date of starting and ending a procedure and Boolean expressions for use in determining, who needs to sign a consent form for a particular patient treatment.

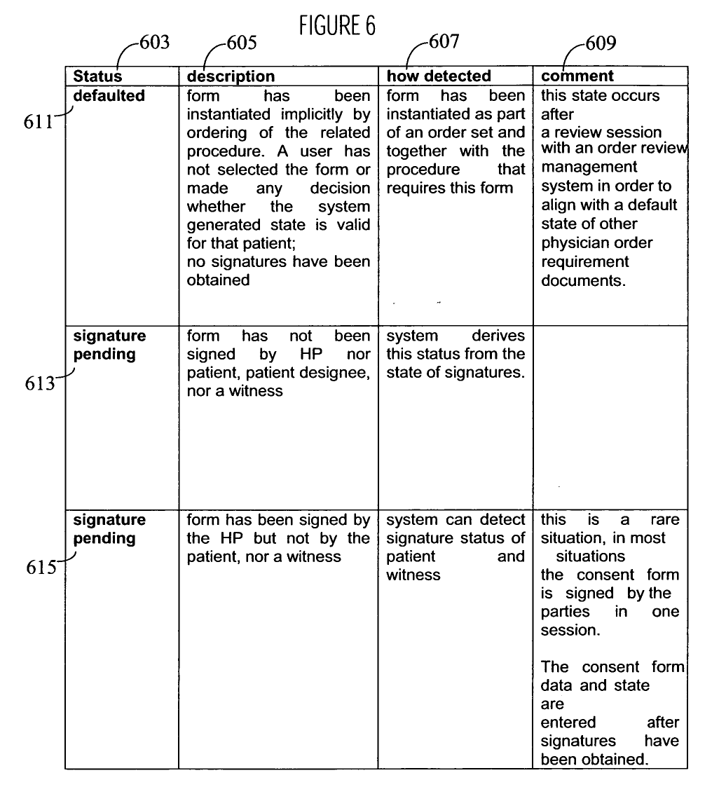

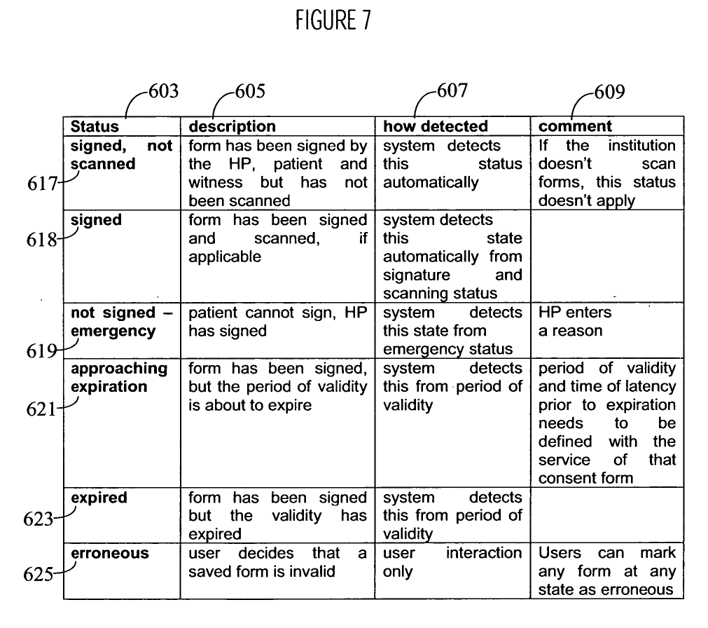

FIGS. 6 and 7 indicate consent management states used in consent status management and tracking system 40. Consent form status is determined based on which of the status indicators 611-625 in column 603 are associated by a user with a patient consent form signature field. A user associates one of the status indicators 611-625 with a patient consent form signature field via a user interface display image provided by user interface system 42. FIGS. 6 and 7 column 605 describes individual status indicators 611-625. Further column 607 details criteria for determining individual status indicators 611-625 are applicable and column 609 provides comments associated with individual status indicators 611-625.

Status indicator 611 identifies a default state automatically assigned based on an order for a treatment procedure by a physician, for example. Indicator 611 is automatically generated by system 40 and indicates a consent form has not been selected by a user and no patient signatures are acquired. Status indicator 611 is assigned after an order review session being performed by a physician, for example, using an order review management system. The indicator identifies consent form status in physician order requirements documents. Status indicator 613 identifies a signature pending state indicating a consent form has not been signed. This state is automatically determined by system 40 based on consent form signature status. In addition, status indicator 615 identifies a signature pending state indicating a consent form has been signed by a healthcare worker but has not been signed by a patient or witness. This state is automatically determined by system 40 based on consent form patient and witness signature status. This state occurs when a healthcare worker, witness and patient are unable to sign a consent form at the same session and data identifying the consent form state is entered into system 40 via interface system 42 when more than one signature but less than the necessary full complement of signatures are obtained.

FIG. 7 status indicator 617 identifies a consent form has been signed by a patient, healthcare worker and witness, for example, but is not scanned into electronic form. System 40 automatically detects this status from workflow progress data indicating a form has been signed together with an absence of a stored scanned representation of the signed form. In an embodiment of system 40 that does not support scanning (or other electronic representation) of consent forms, indicator 617 is not used. Status indicator 618 identifies a consent form has been both signed and scanned into electronic form for storage and access by system 40. System 40 determines this state automatically from signature and scanned status data. Status indicator 619 identifies an emergency state indicating a consent form has been signed by a healthcare worker instead of a patient as the patient is incapable of signing a form. This state is automatically determined by system 40 from emergency status information and involves entry of a reason for the absence of a patient signature by a healthcare worker. Status indicator 621 identifies an approaching expiration state indicating a signed consent form validity period is nearing its end. This state is determined by system 40 from a period of validity determined in response to entry of data signifying a consent form is signed. Status indicator 623 identifies a signed consent form has expired. This state is determined by system 40 from the period of validity of the consent form. Status indicator 625 identifies an erroneous state signifying a saved consent form is invalid. A user (at any time) determines a consent form is invalid and enters data identifying the form as being in this state.

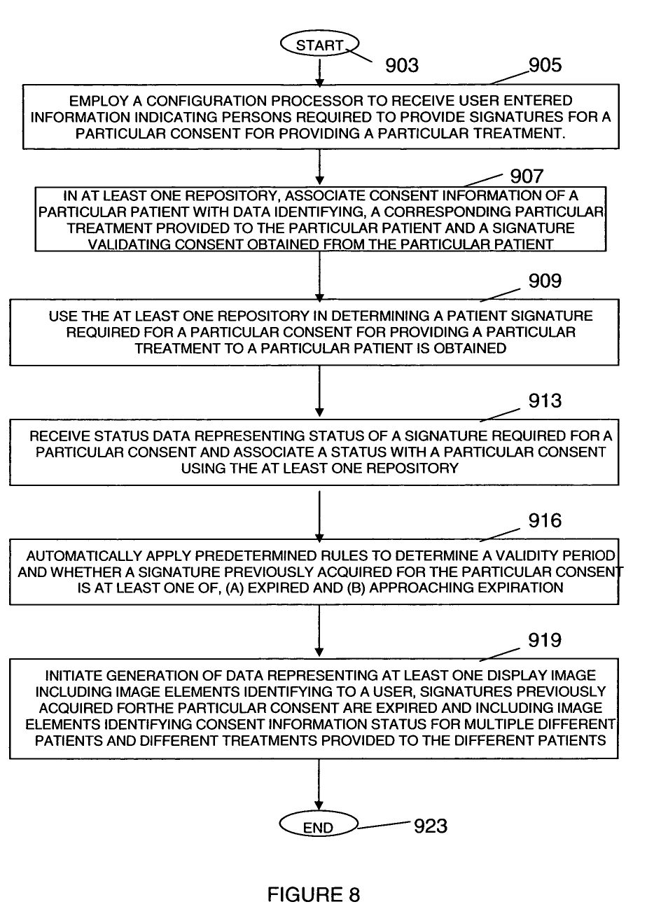

FIG. 8 shows a flowchart of a process employed by consent management system 40. System 40 improves clinical and administrative efficiencies and increases patient safety by increasing the probability of consent forms being complete and accurate prior to procedures being initiated. System 40 automatically associates a consent form with a treatment procedure in a clinical treatment workflow and enables a user to define and electronically value status of required consent form signatures. Further, system 40 automatically identifies consent forms either approaching expiration or that are actually expired. In step 905 following the start at step 903, a configuration processor in system 40 receives user entered information indicating persons required to provide signatures for a particular consent for providing a particular treatment to a particular patient. Alternatively, system 40 applies predetermined rules to determine persons required to provide signatures for a particular consent for providing a particular treatment.

Persons required to provide signatures for a particular consent for providing a particular treatment comprise one or more of, (a) a patient, (b) a healthcare worker (e.g., a physician), (c) a witness and (d) a person designated by a patient. In step 907, system 40 uses at least one repository such as repository 38 to associate consent information of a particular patient with data identifying, a corresponding particular treatment provided to the particular patient and a signature validating consent obtained from the particular patient. The consent information includes a consent form and the at least one repository associates a consent form with a particular treatment. The at least one repository also associates consent information of a particular patient with data identifying a date the particular consent form for providing the particular treatment to the particular patient was obtained.

System 40 in step 909 uses the at least one repository in determining a patient signature required for a particular consent for providing a particular treatment to a particular patient is obtained. Further, in step 913 system 40 automatically derives status data or receives user entered status data representing status of a signature required for a particular consent and associates a status with a particular consent using the at least one repository. The particular treatment may comprise a continuing treatment and in step 916, system 40 automatically applies predetermined rules to determine if a signature previously acquired for the particular consent for providing the particular treatment to the particular patient is expired or approaching expiration. This signifies that the continuing treatment may have to be terminated if a consent is not renewed.

In step 919, a display processor in user interface system 42 initiates generation of data representing at least one display image including image elements identifying to a user that the signatures previously acquired for the particular consent for providing the particular treatment to the particular patient are expired. The at least one display image includes image elements identifying consent information status for multiple different patients and different treatments provided to the different patients. The consent information status identifies one or more of, (a) expiration status of previously obtained consent information, (b) persons providing signatures indicating particular consent for providing a particular treatment to a particular patient and (c) a date the particular consent for providing the particular treatment to the particular patient was obtained. A status signifies a signature required for a particular consent is near expiration or expired, or that a particular signature required for a particular consent is missing or that data representing a particular consent is unavailable in electronic form, for example. The process of FIG. 8 ends at step 923.

Returning to the FIG. 1 system, server device 18 may be implemented as a personal computer or a workstation. Repository (database) 38 associates consent information (e.g., a consent form) of a particular patient with data identifying, a corresponding particular treatment provided to the particular patient and a signature validating consent obtained from the particular patient as well as with data identifying a date the particular consent information was obtained. Repository 38 also contains patient treatment records and other patient records (e.g., financial records). Data storage unit 14 provides an alternate store for patient records, as well as other information in database 38 and system 10. The information in data storage unit 14, repository 38, unit 36 and system 40 is accessed by multiple users from multiple client devices. Patient records in data storage unit 14 include information related to a patient including, without limitation, biographical, financial, clinical, workflow, care plan and patient encounter (visit) related information.

The first local area network (LAN) 16 (FIG. 1) provides a communication network among the client device 12, the data storage unit 14 and the server device 18. The second local area network (LAN) 20 provides a communication network between the server device 18 and repositories 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in system 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

The system and processes presented in FIGS. 1-8 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. 1 and processes of FIG. 1-8 may be implemented in hardware, software or a combination of both. Consent management system 40 is usable to maintain and document patient education in the same manner as consent form management, for example. Consent management system 40 can be used in many different healthcare settings including, hospitals, surgical-centers, outpatient clinics, emergency departments, dialysis centers, cancer centers, blood banks, inpatient or outpatient diagnostic or treatment centers, physician offices, plastic surgery centers, etc.

What is claimed is:

1. A consent information management system suitable for healthcare use, comprising:
at least one repository associating consent information of a particular patient with data identifying,
a corresponding particular treatment provided to said particular patient and
signatures validating consent obtained from said particular patient and other persons; and
a consent data processor for using said at least one repository and determining signatures required for a particular consent for providing a particular treatment to a particular patient are obtained.

2. A system according to claim 1, wherein
said particular treatment is a continuing treatment and
said consent data processor applies predetermined rules to determine a validity period of said particular consent and whether a signature previously acquired for said particular consent for providing said particular treatment to said particular patient is expired.

3. A system according to claim 2, including
a display processor for initiating generation of data representing at least one display image including image elements identifying to a user said signatures previously acquired for said particular consent for providing said particular treatment to said particular patient are expired.

4. A system according to claim 2, including
a configuration processor for receiving user entered information indicating persons required to provide signatures for a particular consent for providing a particular treatment.

5. A system according to claim 1, wherein
said persons required to provide signatures for a particular consent for providing a particular treatment comprise at least two of, (a) a patient, (b) a physician and (c) a witness.

6. A system according to claim 1, wherein
said other persons comprise at least one of, (a) physician and (b) a witness.

7. A system according to claim 1, wherein
said consent information includes a consent form and
said at least one repository associates a consent form with a particular treatment.

8. A system according to claim 1, wherein
said consent data processor applies predetermined rules to determine persons required to provide signatures for a particular consent for providing a particular treatment.

9. A system according to claim 8, wherein
said persons required to provide signatures for a particular consent for providing a particular treatment comprise at least two of, (a) a patient, (b) a physician and (c) a witness.

10. A system according to claim 1, including
a display processor for initiating generation of data representing at least one display image including image elements identifying consent information status for a plurality of different patients and different treatments provided to said plurality of different patients.

11. A system according to claim 10, wherein
said consent information status identifies at least two of, (a) expiration status of previously obtained consent information, (b) persons providing signatures indicating particular consent for providing a particular treatment to a particular patient and (c) a date said particular consent for providing said particular treatment to said particular patient was obtained.

12. A system according to claim 1, wherein
said at least one repository associates consent information of a particular patient with data identifying a date said particular consent for providing said particular treatment to said particular patient was obtained.

13. A system according to claim 1, wherein
said consent data processor receives data representing a clinical note provided by a healthcare worker concerning status of said particular consent for storing in said at least one repository in association with said particular consent.

14. A consent information management system suitable for healthcare use, comprising:
at least one repository associating consent information of a particular patient with data identifying,
a corresponding particular treatment provided to said particular patient and
a signature validating consent obtained from said particular patient; and
a consent data processor for,
using said at least one repository and determining a patient signature required for a particular consent for providing a particular treatment to a particular patient is obtained and
receiving status data representing status of a signature required or a particular consent and associating a status with a particular consent using said at east one repository.

15. A system according to claim 14, wherein
said status signifies a signature required for a particular consent is at least one of, (a) near expiration and (b) expired.

16. A system according to claim 14, wherein
said status data is at least one of, (a) automatically derived and (b) entered by a user.

17. A system according to claim 14, wherein
said status signifies a particular signature required for a particular consent is missing, said particular signature is to be provided by one of, (a) patient, (b) a healthcare worker, (c) a witness and (d) a person designated by a patient.

18. A system according to claim 14, wherein
said status signifies data representing a particular consent is unavailable in electronic form.

19. A system according to claim 14, wherein
said consent data processor automatically applies predetermined rules to determine if a signature previously acquired for said particular consent for providing said particular treatment to said particular patient is at least one of, (a) expired and (b) approaching expiration.

20. A consent information management system suitable for healthcare use, comprising:
at least one repository associating consent information of a particular patient with data identifying,
a corresponding particular treatment provided to said particular patient and
a signature validating consent obtained from said particular patient; and
a consent data processor for,
using said at least one repository and determining a patient signature required for a particular consent for providing a particular treatment to a particular patient is obtained and
automatically applying predetermined rules to determine if a signature previously acquired for said particular consent for providing said particular treatment to said particular patient is at least one of, (a) expired and (b) approaching expiration.

21. A system according to claim 20, wherein
said consent data processor receives status data representing status of a signature required for a particular consent and associates a status with a particular consent using said at least one repository.

22. A system according to claim 20, wherein
said consent data processor automatically derives status data representing status of a signature required for a particular consent and associates a status with a particular consent using said at least one repository.
